(19) United States
(12) Patent Application Publication
(10) Pub. No.: US 2011/0270851 A1
(43) Pub. Date: Nov. 3, 2011

(54) METHOD, DEVICE, AND PROGRAM FOR DETERMINING SIMILARITY BETWEEN DOCUMENTS

(75) Inventors: Takuya Mishina, Kanagawa-ken (JP); Sachiko Yoshihama, Kanagawa-ken (JP)

(73) Assignee: INTERNATIONAL BUSINESS MACHINES CORPORATION, Armonk, NY (US)

(21) Appl. No.: 13/088,457

(22) Filed: Apr. 18, 2011

(30) Foreign Application Priority Data
Apr. 28, 2010 (JP) 2010-104088

(51) Int. Cl. G06F 17/30

(52) U.S. Cl. 707/749; 707/E17.058

(57) ABSTRACT

A method, system and program for detecting similarity between two pieces of document data in which text information and non-text information are mixed. Each data object can include text, non-text, or a combination of text and non-text. The method includes converting each of the pieces of document data to a directed graph, storing the directed graph, and calculating a similarity between the converted directed graphs. In an embodiment, similarity is determined by importance of each object. Importance can be measured by a ratio of the area of the object to the total area of all objects. Moreover, when converting documents to a directed graph, objects can be converted to nodes which are connect to other nodes by edges.

### CROSS-REFERENCE TO RELATED APPLICATION

This application claims priority under 35 U.S.C. §119 to Japanese Patent Application No. 2010-104088 filed Apr. 28, 2010; the entire contents of which are incorporated herein by reference.

### BACKGROUND OF THE INVENTION

1. Field of the Invention

The present invention relates to a method and a system for determining the similarity between a plurality of documents. In particular, the application relates to determining the similarity between documents in which text information and non-text information are mixed.

2. Description of Related Art

The creation of presentation documents steadily expands. A new presentation document is often created on the basis of one or more existing documents. When a confidential document is leaked, concern about company credibility is created, and the risk of financial losses due to the loss of credibility also increases. It is very difficult to stop leakage of a document in question and determine the basis for creating the presentation document. In a case where a document includes only text, methods for comparison are well-known. However, in a presentation document, objects in the presentation document can appear as text, graphics, and mixed images (i.e. include text and non-text information). In documents with such objects, the comparison of documents is not easy.

In Japanese Unexamined Patent Application Publication No. 2007-164648 (also published as a U.S. Published Patent Application No. 2007/0143272) by Kobayashi, the area of each figure is used as the basis for similarity determination in a comparison. More specifically, in a case where two pages are compared, the similarity between the pages is determined by comparing the area ratio between objects on one of the pages with the area ratio between objects on the other page. When the area ratios between objects are different, it is determined that there is no similarity. Moreover, only image information is used, and text information is not considered. Thus, this determination is significantly different from similarity determination performed by a human being and is only effective when a scaled copy of an entire page is made.

In a paper entitled “Retrieval of On-line Hand-Drawn Sketches,” in the 17th International Conference on Pattern Recognition (ICPR '04) by Anoop M. Namboodiri, et al., a method is adopted, in which, vector images are converted to graphical representations, and the similarity between images is calculated as the similarity between graphs. However, in calculation of the similarity between documents including graphics, such as presentation documents, sufficient accuracy cannot be attained by the method because a presentation document includes text data as well as graphical data, and text data significantly influences the characteristics of the document. Moreover, in Namboodiri's method, when the same image object, for example, a company logotype or a clip art that is frequently used across documents, is used in completely different documents, the documents are erroneously detected as similar documents.

In a paper entitled “Marginalized Kernels between Labeled Graphs” in 2003 Proceedings of the Twentieth International Conference on Machine Learning, a method of graph mining based on a random walk is described by H. Kashima et al. The paper does not describe a method of acquiring the similarity between texts or the similarity between documents using the area ratio between objects.

### SUMMARY OF THE INVENTION

In view of the aforementioned situations, it is an object of the present invention to provide a technique for detecting the similarity between documents in which text information and non-text information are mixed, a technique for detecting the similarity between documents considering the importance of each object, and a technique for performing determination of the similarity between documents closely fit to human feeling about the similarity between documents at a glance.

In one aspect, the present invention provides a computer-executable method of supporting determination of a similarity between two pieces of document data. The pieces of document data include objects including text, non-text, or a combination of text and non-text. The method includes the steps of converting each of the pieces of document data to a directed graph and storing the directed graph, and calculating a similarity between the converted directed graphs by operations by a computer using an importance of each object.

In a second aspect of the invention, a computer-executable system supporting determination of a similarity between two pieces of document data is provided. The pieces of document data include objects including text, non-text, or a combination of text and non-text. The system includes means for converting each of the pieces of document data to a directed graph and storing the directed graph, and means for calculating a similarity between the converted directed graphs by operations by a computer using an importance of each object.

In a further aspect of the invention, a computer program for supporting determination of a similarity between two pieces of document data is provided as another aspect. The computer program causes a computer to perform the steps in each of the aforementioned methods.

### BRIEF DESCRIPTION OF DRAWINGS

FIG. 1 illustrates the outline of a process according to an embodiment of the current invention.

FIG. 2 illustrates a more detailed flowchart of the flow of converting pieces of document data to labeled directed graphs according to an embodiment of the current invention.

FIG. 3 illustrates exemplary features of a node and an edge according to an embodiment of the current invention.

FIG. 4 illustrates an exemplary conversion to a directed graph in a case where a presentation chart is used as document data according to an embodiment of the current invention.

FIG. 5 illustrates an internal data structure of features of a node according to an embodiment of the current invention.

FIG. 6 illustrates a data structure of the label of an edge according to an embodiment of the current invention.

FIG. 7 illustrates a block diagram of a document similarity determination system according to an embodiment of the current invention.

FIG. 8 illustrates a detailed flowchart of the document similarity determination system according to an embodiment of the current invention.

FIG. 9 illustrates a more detailed flowchart of the process for comparing pages for the similarity according to an embodiment of the current invention.

FIG. 10 illustrates exemplary hardware blocks of a document data similarity determination system according to an embodiment of the current invention.

FIG. 11 is a diagram illustrating a more practical comparison method according to an embodiment of the current invention.

### DETAILED DESCRIPTION OF THE PREFERRED EMBODIMENTS

Detailed description of the invention is made in combination with the following embodiments. In the following description, the same components are denoted by the same reference numerals throughout the drawings unless otherwise noted. In addition, the following configuration and the process are described merely as an embodiment of the present invention. Thus, it is to be understood that the technical scope of the present invention is not intended to be limited to this embodiment.

The use of the present invention enables detection of the similarity between documents in which text information and non-text information are mixed and detection of the similarity between documents considering the importance of each object. In the present invention, the larger the area of an object is, more frequently the object is subjected to comparison. Thus, the larger an object is, the more the object is caused to contribute to similarity calculation. In this arrangement, a computer can be caused to perform determination closely fit to human feeling about the similarity between documents at a glance.

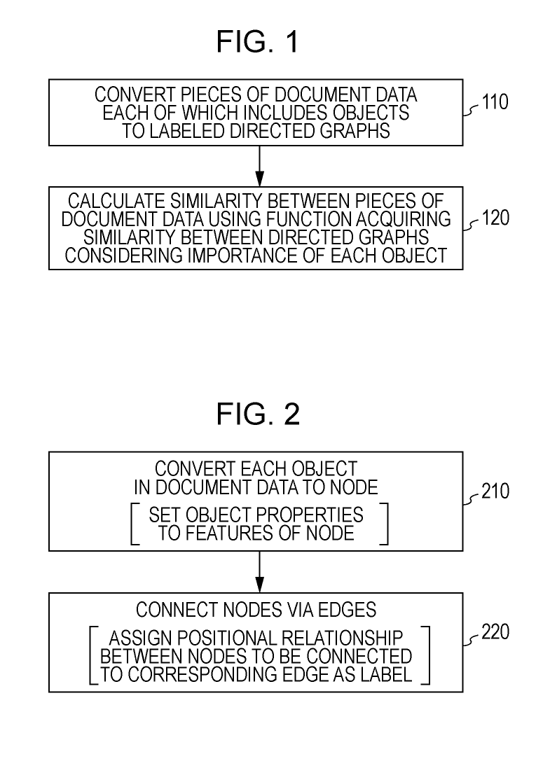

The outline of a process in the present invention is shown in FIG. 1. In step 110, pieces of document data each of which includes objects are converted to labeled directed graphs. At this time, each of the objects is converted to a node, and the features of the object are calculated. Then, the nodes are connected via edges. The geographical position relationship between nodes to be connected is used as a label assigned to a corresponding edge. Then, in step 120, the similarity between the pieces of document data is calculated using a function acquiring the similarity between directed graphs. The calculation can be performed using the importance of each object in addition to the features of each node and the positional relationship of edges. The importance of each object may be a ratio (an area ratio) of an area of the object to a total area of all the objects. In an embodiment of the present invention, the area of an object is considered as the importance of the object. Alternatively, another index, for example, information in proportion to a special shape or an importance embedded using a digital watermarking technique, can be used without departing from the essence of the present invention. In an embodiment of the present invention, the ratio of an object to the total area of all objects (area ratio) is used as the importance of the object in similarity calculation for nodes and edges.

FIG. 2 shows a more detailed flowchart of step 110 of converting pieces of document data to labeled directed graphs. In step 210, each object in document data is first converted to a node. At this time, the properties of the object are set to the features of the node. Then, in step 220, the nodes are connected via edges. The positional relationship between nodes to be connected is assigned to a corresponding edge as a label.

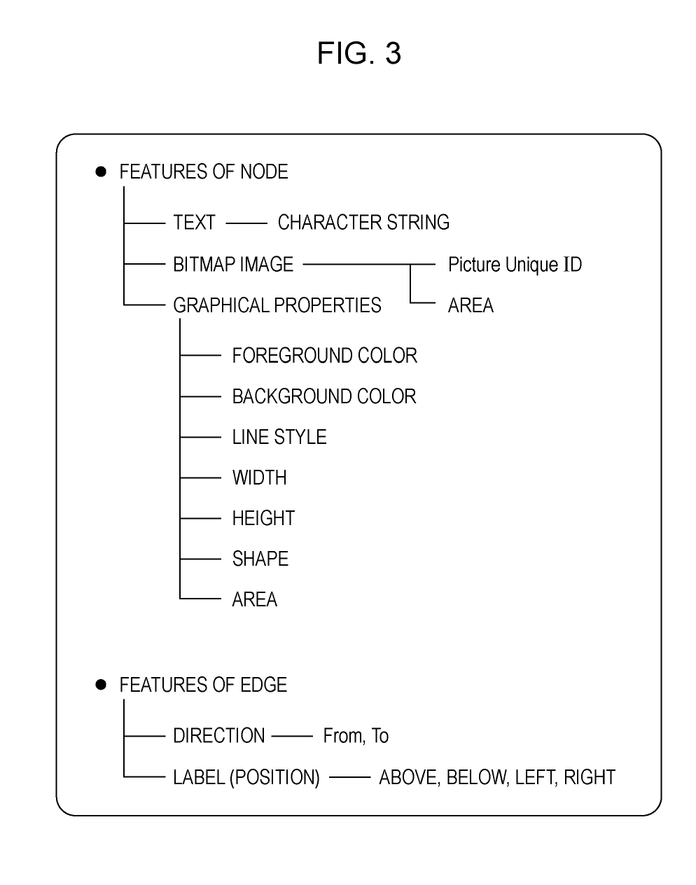

FIG. 3 illustrates the properties of an object in relation to a node and an edge. Features that are possessed by a node when document data is converted to a labeled directed graph mainly include text, a bitmap image, and graphical properties. The content of text includes a character string. A bitmap image includes the user ID of the author and the area. Graphical properties include a foreground color, a background color, a line style, a width, a height, a shape, and an area. Features that are possessed by an edge include a direction and a label. A direction holds information indicating from which node to which node the direction extends. A label holds geographical position information.

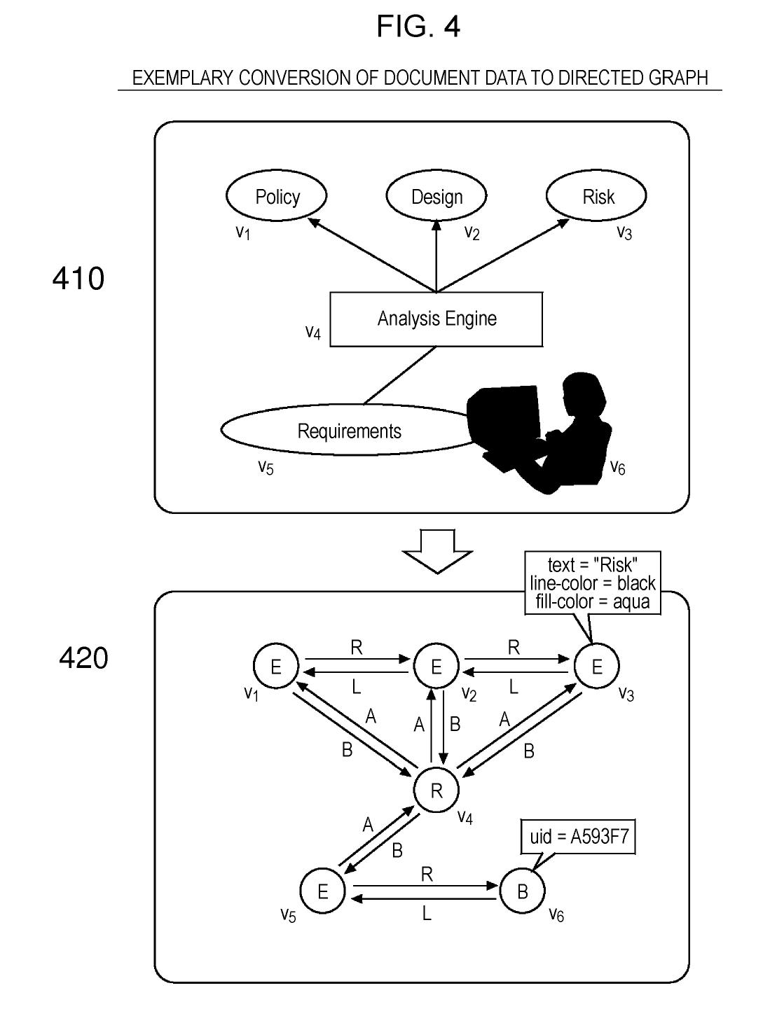

FIG. 4 shows exemplary conversion to a directed graph in a case where a presentation chart is used as document data. An original chart 410 is in the upper portion of FIG. 4, while the lower figure shows a directed graph 420 to which the chart is converted. Signs v1, v2, v3, v4, v5, and v6 each denote a node. Signs v1, v2, v3, v4, v5, and v6 in the original chart 410 are described for clearly expressing the correspondence to the directed graph 420 and are not described in an actual chart.

Each node possesses features. The features possessed by the node may include text, an image, or graphical properties. For example, in the node v3, the text is “Risk”, the line color is black, and the fill color is aqua. Whereas the node v6 possesses an identifier unique to a bitmap, and the UID is A593F7. Furthermore, in the directed graph 420, “E” in a node indicates that the shape of an original object is an ellipse; “R” in a node indicates that the shape of an original object is a rectangle; and “B” in a node indicates that an original object is bitmap graphics.

In the directed graph 420, edges are denoted by arrows. Labels A, B, L, and R of edges denote above, below, left, and right, respectively. For example, in the case of the relationship between the nodes v1 and v2, corresponding labels indicate a positional relationship in which the node v2 is located on the right side of the node v1. Thus, the information indicating the positional relationship can be above, below, left, or right.

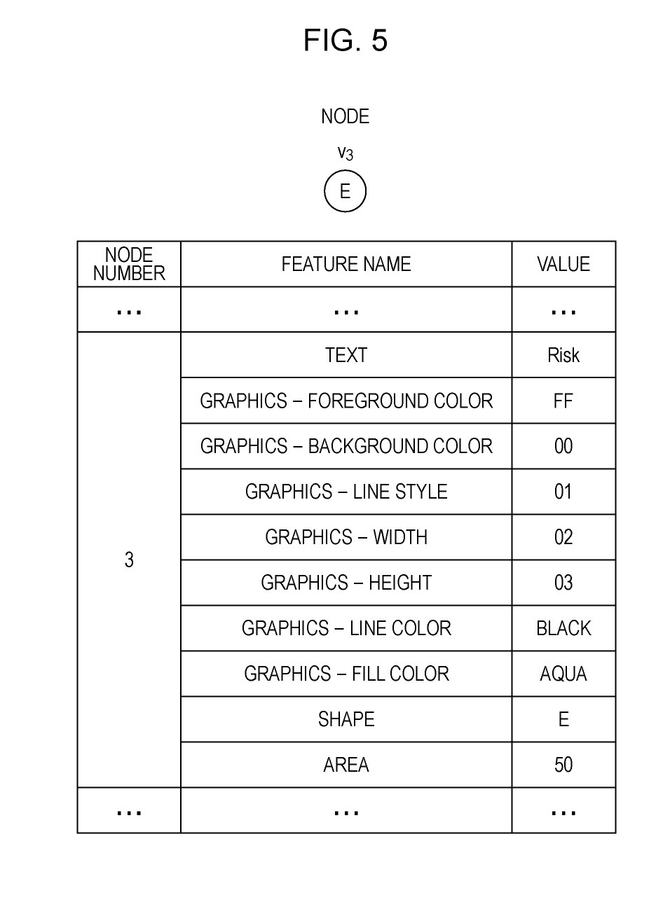

FIG. 5 shows the internal data structure of features of an exemplary node. This data structure is stored in a memory. In FIG. 5, the node v3 is illustrated. It will be appreciated that a feature name and then a value are stored for each node number. The case in FIG. 5 is a case where the shape of a corresponding object is an ellipse. For example, in the case of the node v6, the shape of a corresponding object is B, a unique ID is contained in the feature name, and A593F7 is contained in the value. FIG. 5 just shows an example, and many types of features can be appropriately considered in a manner that depends on the type of an object.

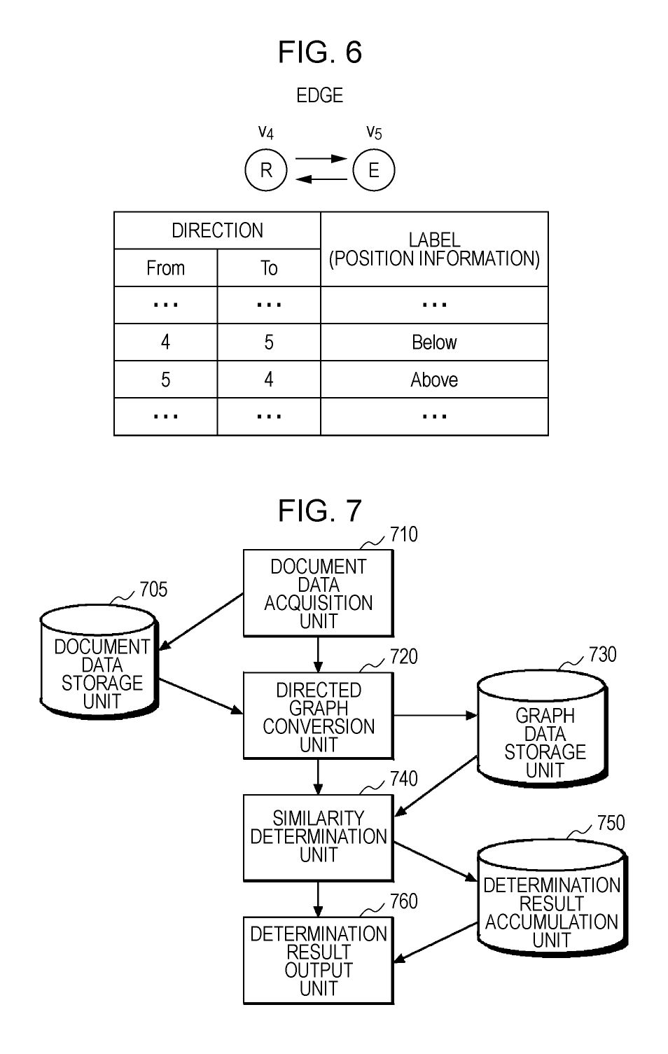

FIG. 6 shows the data structure of the label of an edge. This data structure is also stored in a memory. In FIG. 6, edges between the nodes v4 and v5 are illustrated. Edge features include a direction and a label. A direction includes “From” and “To” indicating from which node to which node the direction extends, and node numbers are set in “From” and “To” as values. One of the values of geographical position information, “above”, “below”, “left”, and “right”, is set in a label. The geographical position information indicates at which position in relation to a node at the origin of a corresponding edge a node at the destination of the edge is located. Since the node v5 is located below the node v4, “below” is set in a corresponding value. Moreover, since the node v4 is located above the node v5, “above” is set in a corresponding value.

### Embodiments

A similarity determination method employing graph mining by a kernel method is disclosed as an embodiment. Graph mining can calculate the similarity of data that can be represented by a graph, such as a molecular structure, and is used for the purpose of, for example, searching for a substance having specific properties on the basis of the acquired similarity. Since methods for graph mining are known, a detailed method is omitted. For example, Kashima proposes a method in which a random walk and a kernel method are combined, out of graph mining methods. Thus, an example in which a kernel function suitable for determining the similarity of document data is defined and used in similarity determination will now be shown as the embodiment of the present invention.

Outline of Graph Mining

The step of calculating the similarity between the directed graphs can be performed by graph mining. The step of calculating the similarity by graph mining can be performed by graph mining based on a random walk. Assume that the converted directed graphs are G and G′. In graph mining based on a random walk, a kernel function K(G,G′) indicating similarity between two labeled directed graphs G and G′ is expressed as follows:

$$K ( G , {G}^{′} ) = {\sum }_{l = 1}^{∞} {\sum }_{h} {\sum }_{{h}^{′}} {p}_{s} ( {h}_{1} ) {\prod }_{i = 2}^{l} {p}_{t} ( {h}_{i} \vert {h}_{i - 1} ) {p}_{q} ( {h}_{1} ) \times {p}_{s}^{′} ( {h}_{1}^{′} ) {\prod }_{j = 2}^{l} {p}_{t}^{′} ( {h}_{j}^{′} \vert {h}_{j - 1}^{′} ) {p}_{q}^{′} ( {h}_{l}^{′} ) \times K ( {v}_{{h}_{1}} , {v}_{{h}_{1}^{′}}^{′} ) {\prod }_{k = 2}^{l} K ( {e}_{{h}_{k - 1} , {h}_{k}} , {e}_{{h}_{k - 1}^{′} , {h}_{k}^{′}}^{′} ) K ( {v}_{{h}_{k}} , {v}_{{h}_{k}^{′}}^{′} ) \qquad [ E1 ]$$

where ps(i) is the probability that a random walk starts from a node i,

pt(j|i) is the transition probability that a transition from a node i to a node j occurs,

pq(i) is the probability that a random walk ends at a node i,

K(v,v′) is a kernel function indicating the similarity between a pair of nodes (v,v′), and

K(e,e′) is a kernel function indicating the similarity between a pair of edges (e,e′).

A value of ps(i) or pt(j|i) may be increased in proportion to a ratio (an area ratio) of an area of each object to a total area of all the objects.

In Kashima, uniform distributions are used as ps and pt, and a constant is used as pq. Moreover, regarding K(v,v′) and K(e,e′), functions returning 1 when nodes or labels assigned to edges match each other and 0 otherwise are used. In the present invention, it is assumed that similar functions are used.

In short, a kernel function can be considered to be the inner product of two feature vectors in a feature space. Thus, a kernel function can be considered to be a function returning a high value for a pair of vectors having similar characteristics and a low value for a pair of vectors having different characteristics. That is, K(G,G′) can be said to express in what degree the respective structures of the two graphs G and G′ are similar. Thus, the similarity between a pair of pages of pieces of document data the similarity between which needs to be measured can be acquired by converting the pair of pages to graphs and acquiring the value of a kernel function between the graphs.

Application of Graph Mining to Document Similarity Determination

The step of calculating the similarity by graph mining may be performed using a probability that an operation starts from a node i, a probability that a transition to a node j connected to the node i via an edge occurs, a probability that an operation ends at the node i, a kernel function indicating a similarity between a pair of nodes (v,v′), and a kernel function indicating a similarity between a pair of edges (e,e′).

In order to apply graph mining to document data including text and non-text data, the procedure for converting each page included in document data to a graph structure and parameters (ps, pt, pq, K(v,v′), and K(e,e′)) necessary for graph mining are determined as follows.

Conversion to Graph Structure

Document data (for example, a page in a presentation document) is first converted to a labeled directed graph. Objects are first converted to nodes. Considering that the properties (including text) of each of the objects are features possessed by a corresponding one of the nodes, the properties are used in calculation of K(v,v′) described below. Then, the nodes are connected via edges. At this time, the geographical position relationship (above, below, left, or right) between nodes to be connected is used as a label assigned to a corresponding edge. A graph structure robust to a minor correction will be sought by intentionally using an edge label with a coarse granularity. For exemplary conversion to a directed graph, refer to FIG. 4.

Random Walk Parameters

Parameters ps(i), pt(j|i), and pq(i) related to a random walk will next be determined. At this time, the degree in which each node is considered can be changed by adjusting ps(i) and pt(j|i) for the node. Thus, this time, the parameters are adjusted so that much importance is attached to major objects, and little importance is attached to minor objects. Specifically, the transition probability is assigned to each object in proportion to the ratio of an area occupied by the object to a corresponding page. For example, in a case where the area of the node v6 is 100 square pixels, the area of the node v4 is 50 square pixels, and the total of the respective areas of all the objects is 1000 square pixels in FIG. 4, ps(v6)=100/1000, and thus:

pt(v6|v5)=100/(100+50)

pt(v4|v5)=50/(100+50)

Moreover, when a start node in a random walk is selected using a random number, the likelihood of each object being selected is increased in proportion to the ratio of an area occupied by the object to a corresponding page. Regarding the probability that a transition from a node to another node occurs, the likelihood of a transition to a large-area object (node) occurring is increased, as described above. Determination in which the importance of each object is considered can be performed by increasing the likelihood of a large-area object being selected in this manner. That is, determination of the similarity between documents closely fit to human feeling about the similarity between documents at a glance can be performed. In this case, instead of an area ratio, for example, a similarity in shape indicating how an object is close to a specific shape or an invisible importance embedded using a digital watermarking technique can be used as the importance of an object.

Kernel Function for Node and Edge

A kernel function is a function returning a high value for a pair of vectors having similar characteristics and a low value for a pair of vectors having different characteristics. Any function that satisfies some conditions, for example,

(K(x,y)=K(y,x), K(x,y)>0

can be used as a kernel function.

To begin with, regarding K(v,v′), the following degrees of match in properties are acquired by linear interpolation. Features (properties) of each node and each edge are stored in a memory, as shown in the exemplary data structure in FIG. 5.

Regarding text, the percentage of common words occurring in a pair of nodes (Jaccard index) is used. That is, the degree of match in text is measured by comparing texts and using information indicating at what percent the same words are used.

Regarding a bitmap image, it is determined whether a Picture Unique ID that is an ID unique to an image is the same.

Regarding graphical properties, the degree of match in, for example, each of the foreground color, the background color, the line style, the width, and the height is determined.

Regarding K(e,e′), a function returning 1 when labels match each other and 0 otherwise is used. For the exemplary data structure of each edge, refer to FIG. 6. The foregoing is exemplary, and it is understood that various changes can be made.

FIG. 7 shows a block diagram of a document similarity determination system of an embodiment of the present invention. A document data acquisition unit 710 reads document data and stores the document data in a document data storage unit 705. Then, a directed graph conversion unit 720 reads the document data from the document data storage unit 705, converts the document data to a directed graph, and then stores the directed graph in a graph data storage unit 730. Then, a similarity determination unit 740 reads the graph data stored in the graph data storage unit 730, determines the similarity, and then stores the result in a determination result accumulation unit 750. When similarity determination has been performed on all the pages of the document data, a determination result output unit 760 outputs the final result of similarity determination from accumulated data in the determination result accumulation unit 750.

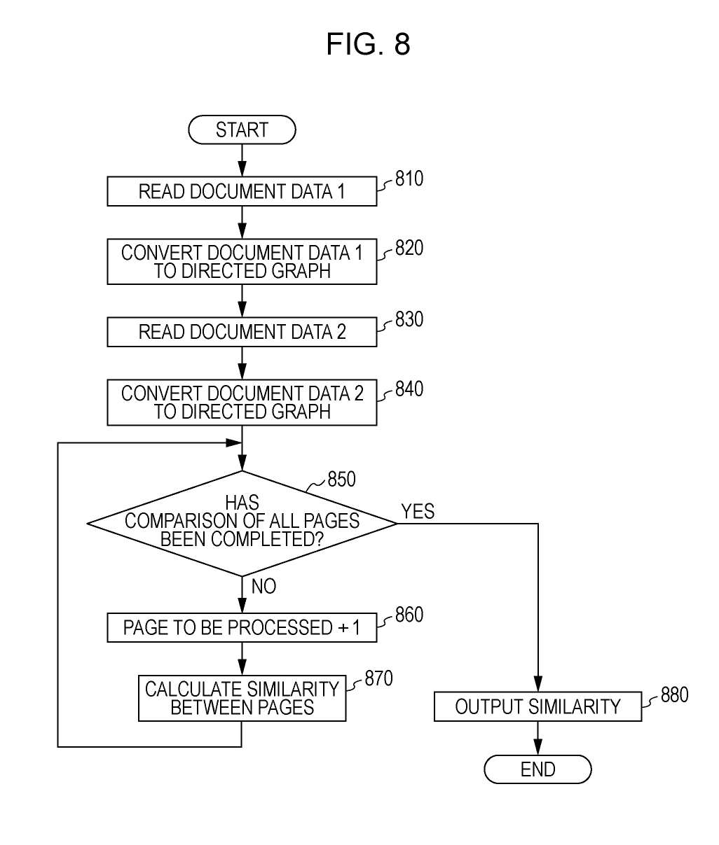

FIG. 8 shows a detailed flowchart of the document similarity determination system of the present invention. In step 810, all pages of document data 1 are first read and stored in the document data storage unit 705. Then, in step 820, the document data 1 stored in the document data storage unit 705 is read, all the pages are converted to a directed graph, and then the directed graph is additionally stored as graph data 1 in the graph data storage unit 730. Similarly, in step 830, all pages of document data 2 are read and stored in the document data storage unit 705. Then, in step 840, the document data 2 stored in the document data storage unit 705 is read, all the pages are converted to a directed graph, and then the directed graph is additionally stored as graph data 2 in the graph data storage unit 730.

In step 850, it is determined whether comparison of all the pages for the similarity has been completed. When the comparison has been completed, in step 880, the final result of similarity determination is output from accumulated data in the determination result accumulation unit 750 as a probability (continuous value) ranging from 0% to 100%. When the similarities between pages are probabilities, the final similarity is preferably calculated as the average of the probabilities. Alternatively, when the similarities between pages are absolute values, the final similarity can be the total sum. In any case, the similarities between pages are output after being integrated. When comparison of all the pages has not been completed in step 850, in step 860, the pages to be processed are advanced by one page. Then, in step 870, the pages to be processed are read from the graph data 1 and the graph data 2 in the graph data storage unit 730, and the similarity between the pages is calculated. Then, the result is additionally stored in the determination result accumulation unit 750.

In the case of actual presentation documents, a document 1 and a document 2 are not necessarily composed of the same number of pages and are subjected to various types of edit operations, for example, deletion and movement. Thus, in the present invention, a more practical comparison method is adopted. FIG. 11 illustrates a practical comparison method. In FIG. 11, it is assumed that the graph data 1 is composed of n pages, and the graph data 2 is composed of m pages. The number of all combinations of pages to be compared is nm.

In one determination method, when each of nm pairs is similar, entire documents are considered similar. In this determination method, although erroneous detection is infrequent, only exact reuse can be detected, and thus partial reuse can not be detected.

In another method, when the similarity between at least one pair, out of the nm pairs, exceeds a predetermined threshold t, entire documents can be considered similar. In this arrangement, even when only one page is reused, all similar documents can be detected. This determination method that can perform comprehensive detection is suitable for a case where omission of information in reuse needs to be prevented.

Moreover, when it is determined documents are similar; an alarm can be instantaneously given to a user. In this case, since it is essential only that whether the overall similarity is 0 (no alarm) or 1 (alarm) be determined, when the threshold t has been exceeded in any one of the nm pairs, the process is terminated, and information indicating that documents are similar is displayed. Furthermore, various changes can be made.

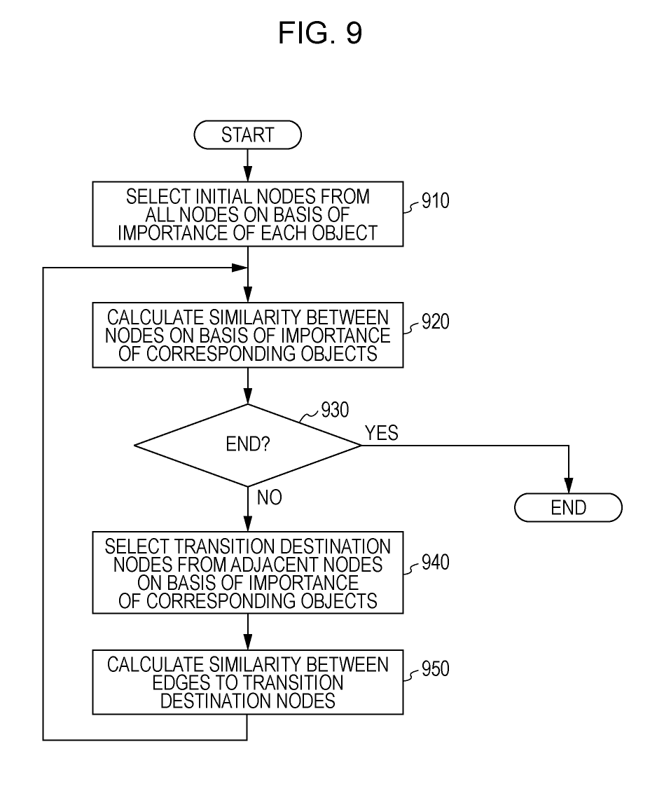

FIG. 9 shows a more detailed flowchart of the process for comparing pages for the similarity in step 870. In the flowchart in FIG. 9, the similarity between pages to be processed in the graph data 1 and the graph data 2 stored in the graph data storage unit 730 is calculated. Regarding pages to be processed, in selection of nodes from which comparison is started, the same node is not necessarily selected by a function depending on the probability including the importance of an object (the area ratio of an object). Moreover, even when start nodes are the same, transition destination nodes to which there is a transition from the start nodes are not necessarily the same. In the algorithm of a random walk, calculation is performed while causing transitions to a plurality of nodes connected via edges at the same time, and the similarities between paths up to the end of the process are summed up. It should be noted that the description is limited to a transition from a single node to a single node in FIG. 9 for convenience of explanation.

In step 910, initial nodes from which comparison is started are first selected from all nodes. A node is selected from the graph data 1, and a node is selected from the graph data 2. At this time, nodes, the importance (area ratio) of objects corresponding to the nodes being high, are likely to be selected. Then, in step 920, the similarity between the nodes is calculated using the aforementioned kernel function K(v,v′) indicating the similarity between a pair of nodes (v,v′). Then, in step 930, it is determined, on the basis of the aforementioned termination probability pq(i) that a random walk ends at a node i, whether a condition for terminating the process has been met. When the condition has been met, the process is terminated. When the condition has not been met, in step 940, transition destination nodes are selected from adjacent nodes on the basis of the aforementioned transition probability pt(j|i) that a transition from a node i to a node j occurs. At this time, nodes, the importance (area ratio) of objects corresponding to the nodes being high, are likely to be selected. Then, in step 950, the similarity between respective edges to the transition destination nodes is calculated using the aforementioned kernel function K(e,e′) indicating the similarity between a pair of edges (e,e′), and the result is additionally stored in the determination result accumulation unit 750. Then, the process returns to step 920.

Block Diagram of Computer Hardware

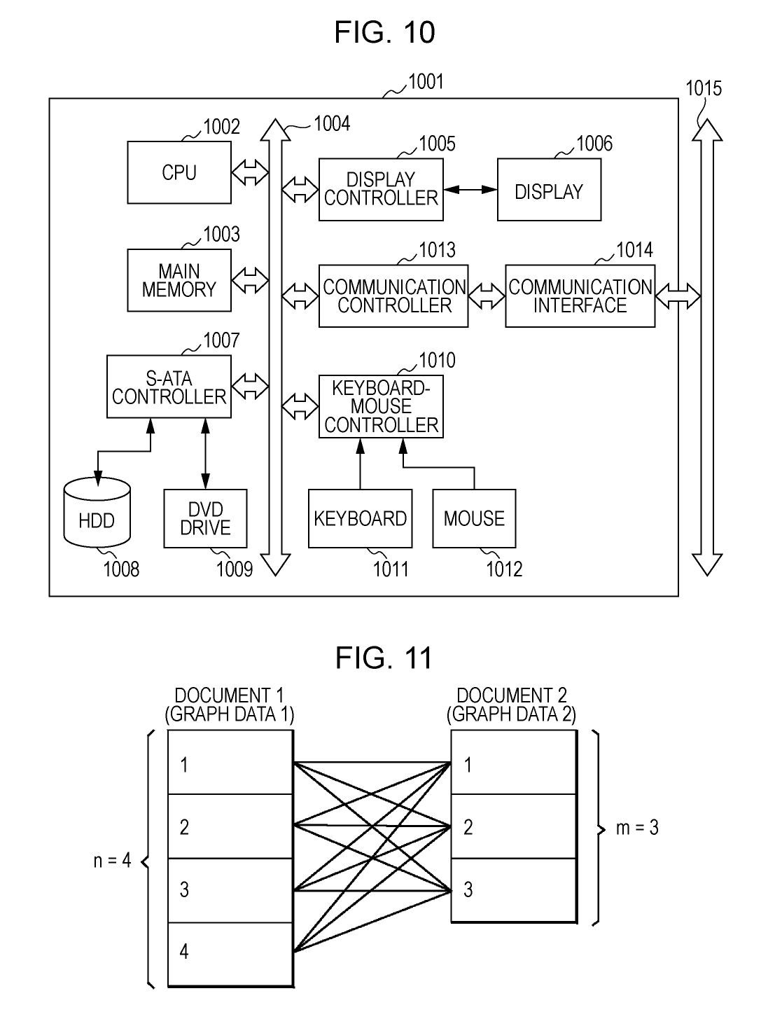

FIG. 10 shows a block diagram of the computer hardware of a document data similarity determination system of the present invention as an example. A computer system (1001) according to an embodiment of the present invention includes a CPU (1002) and a main memory (1003) connected to a bus (1004). The CPU (1002) is preferably based on the 32-bit or 64-bit architecture. For example, the Xeon™ series, the Core™ series, the Atom™ series, the Pentium™ series, or the Celeron™ series of Intel Corporation or the Phenom™ series, the Athlon™ series, the Turion™ series, or Sempron™ of AMD can be used as the CPU (1002).

A display (1006) such as an LCD monitor is connected to the bus (1004) via a display controller (1005). The display (1006) is used to display document data, a converted directed graph, and the result of similarity determination. A hard disk or a silicon disk (1008) and a CD-ROM, DVD, or Blu-ray drive (1009) are connected to the bus (1004) via an IDE or SATA controller (1007). Programs and data according to the present invention can be stored in these storage units. Programs, document data, and converted directed graph data of the present invention are stored in the hard disk (1008) or the main memory (1003), and the process for similarity determination is performed by the CPU (1002). Moreover, determination result accumulated data is preferably stored in the hard disk (1008). Then, the final similarity determination is displayed on the display (1006).

The CD-ROM, DVD, or Blu-ray drive (1009) is used to install, to the hard disk, programs of the present invention from or read data from a CD-ROM, a DVD-ROM, or a Blu-ray disk that are computer-readable media as necessary. Moreover, a keyboard (1011) and a mouse (1012) are connected to the bus (1004) via a keyboard-mouse controller (1010).

A communication interface (1014) is based on, for example, the Ethernet (trademark) protocol. The communication interface (1014) is connected to the bus (1004) via a communication controller (1013), physically connects the computer system to a communication line (1015), and provides a network interface layer to the TCP/IP communication protocol that is a communication function of an operating system of the computer system. In this case, external document data or directed graphs can be read via the communication line and can be processed by the CPU (1002).

A document similarity determination method of the present invention can be implemented by a device-executable program written in, for example, an object-oriented programming language, such as C++, Java®, Java® Beans, Java® Applet, Java® Script, Perl, or Ruby, or a database language, such as SQL. Moreover, the program can be stored in a computer-readable recording medium or transmitted for distribution.

While the present invention has been described using a specific embodiment, the present invention is not limited to the specific embodiment. Other embodiments, additions, changes, and deletions could be made within a range that could be easily reached by those skilled in the art and are included in the scope of the present invention as long as the operations and advantages of the present invention are achieved.

What is claimed is:

1. A computer-executable method of determining a similarity between two pieces of document data, the pieces of document data including objects including text, non-text, or a combination of text and non-text, the method comprising the steps of:
converting each of the pieces of document data to a directed graph;
storing the directed graphs; and
calculating a similarity between the directed graphs using an importance of each object.

2. The method according to claim 1, wherein the importance of each object is an area ratio wherein the area ratio is a ratio of an area of the object to a total area of all the objects.

3. The method according to claim 1, wherein the step of converting to a directed graph includes the steps of:
converting objects to nodes;
storing the nodes;
connecting the nodes via edges; and
storing information indicating a positional relationship between the connected nodes;
wherein each node has at least one feature.

4. The method according to claim 3, wherein the feature comprises text, an image, or graphical properties.

5. The method according to claim 3, wherein the information indicating the positional relationship comprises above, below, left, or right.

6. The method according to claim 1, wherein the step of calculating the similarity between the directed graphs is performed by graph mining.

7. The method according to claim 6, wherein the step of calculating the similarity by graph mining is performed using a probability that an operation starts from a node i, a probability that a transition to a node j connected to the node i via an edge occurs, a probability that an operation ends at the node i, a kernel function indicating a similarity between a pair of nodes (v,v′), and a kernel function indicating a similarity between a pair of edges (e,e′).

8. The method according to claim 7, wherein the step of calculating the similarity by graph mining is performed by graph mining based on a random walk, and is calculated using:
a probability, ps(i), that a random walk starts from the node i;
a transition probability, pt(j|i), that a transition from the node i to the node j occurs;
a probability, pq(i), that a random walk ends at the node i;
a kernel function, K(v,v′), indicating a similarity between the pair of nodes (v,v′);
a kernel function, K(e,e′), indicating a similarity between the pair of edges (e,e′); and
a value, consisting of the value of ps(i) or the value of pt(jIi), is increased in proportion to an area ratio wherein the area ratio is a ratio of an area of each object to a total area of all the objects; and
wherein
the converted directed graphs are G and G′ and
a kernel function K(G,G′) indicates a similarity between the directed graphs G and G′.

9. A computer-executable system supporting determination of a similarity between two pieces of document data, the pieces of document data including objects including text, non-text, or a combination of text and non-text, the system comprising:
means for converting each of the pieces of document data to a directed graph and storing the directed graphs; and
means for determining a similarity between the directed graphs.

10. The system according to claim 9, wherein an importance of each object is used to determine the similarity, wherein the importance of each object is a ratio of an area of the object to a total area of all the objects.

11. The system according to claim 9, wherein the means for converting to a directed graph includes:
means for converting objects in document data to nodes and storing properties of each of the objects as features possessed by a corresponding one of the nodes, and
means for connecting the nodes via edges and storing information indicating a positional relationship between the nodes to be connected.

12. The system according to claim 11, wherein the features possessed by the node include text, an image, or graphical properties.

13. The system according to claim 11, wherein the information indicating the positional relationship is above, below, left, or right.

14. The system according to claim 9, wherein determination of the similarity between the directed graphs is performed by graph mining.

15. The system according to claim 14, wherein the determination of the similarity by graph mining is performed using a probability that an operation starts from a node i, a probability that a transition to a node j connected to the node i via an edge occurs, a probability that an operation ends at the node i, a kernel function indicating a similarity between a pair of nodes (v,v′), and a kernel function indicating a similarity between a pair of edges (e,e′).

16. The system according to claim 15, wherein the determination of the similarity by graph mining is performed by graph mining based on a random walk, and, assuming that the converted directed graphs are G and G, when a kernel function K(G,G′) indicating a similarity between the directed graphs G and G′ is calculated using:
ps(i): a probability that a random walk starts from the node I;
pt(j|i): a transition probability that a transition from the node i to the node j occurs;
pq(i): a probability that a random walk ends at the node I;
K(v,v′): a kernel function indicating a similarity between the pair of nodes (v,v′);
K(e,e′): a kernel function indicating a similarity between the pair of edges (e,e′); and
wherein a value of ps(i) or pt(j|i) is increased in proportion to a ratio (an area ratio) of an area of each object to a total area of all the objects.

17. An article of manufacture tangibly embodying computer readable instructions which, when implemented, cause a computer to carry out the steps of a method according to claim 1.
